(19) United States
(12) Patent Application Publication
(10) Pub. No.: US 2010/0182505 A1
(43) Pub. Date: Jul. 22, 2010

(54) VIDEO RECEIVER

(75) Inventor: Pradeep Kumar Jilagam, Hyderabad (IN)

Correspondence Address: DLA PIPER LLP (US), 2000 UNIVERSITY AVENUE, EAST PALO ALTO, CA, 94303, US

(73) Assignee: Trident Microsystems ( Far East) Ltd. a corporation

(21) Appl. No.: 12/600,659

(22) PCT Filed: Jun. 6, 2008
(86) PCT No.: PCT/IB2008/052237

§ 371 Date: Nov. 18, 2009

(30) Foreign Application Priority Data
Jun. 11, 2007 (EP) 07109991.5

(51) Int. Cl. H04N 5/44

(52) U.S. Cl. 348/553; 348/E05.096

(57) ABSTRACT

There is provided a method for displaying a video signal (31; 46) on a display (20; 44), a video receiver (32; 43), and software. When the video signal is received, the video receiver displays the video pictures of the video signal within a reduced-size window (24; 50) on the display. Then, the size of the reduced-size window is gradually increased, and the video receiver simultaneously detects the format of the video pictures. Once the format of the video pictures has been detected, the size of the window continues to be increased, but taking into account the detected format, thereby finally giving a full-size window (26; 55) that matches the format of the video pictures.

This invention relates to an improved method and apparatus for displaying a video signal, and more particularly to displaying a newly received video signal.

Video signals typically comprise video pictures for display, and the video pictures typically have a standard aspect ratio, for example 4:3 (video picture width:height). The formatting of the video pictures is such that the standard aspect ratio of the video pictures is not always equivalent to the aspect ratio of the actual (active) video content that is to be displayed. For example, the aspect ratio of the video pictures may be 4:3, but the aspect ratio of the active video content to be displayed may be 16:9.

One known method of encoding the 16:9 active video content into the 4:3 video pictures, is to insert black bars above and below the 16:9 active video content in order to fill the 4:3 video pictures. Hence, the 4:3 video pictures are formatted to comprise an active portion having a 16:9 aspect ratio, and two inactive portions in the form of black bars above and below the active portion.

Another known method is to encode the 16:9 active video content into the 4:3 video pictures, by horizontally scaling the 16:9 active video content so that it fits into the 4:3 video pictures. Hence the 4:3 video pictures are formatted to comprise only an active portion. Additionally, another known method is to create the 16:9 active video content using an anamorphic lens, the anamorphic lens horizontally scaling the 16:9 active video content into 4:3 video pictures.

Upon switching to a new video signal, a video receiver will typically determine the format of the received video pictures of the new video signal, in order to display the active video content at the correct size and aspect ratio.

For example, the video receiver may determine that the video pictures are formatted such that black bars are present at the top and bottom of the received 4:3 video pictures. Then, the receiver may remove the black bars and display only the remaining (active) portion of the video pictures.

As another example, the video receiver may receive information specifying that the video pictures are formatted such that the received 4:3 video pictures are horizontally scaled from an original aspect ratio of 16:9. Then, the receiver may horizontally stretch the received 4:3 video pictures to provide the 16:9 active video content for display.

For a discussion of how the aspect ratio of a displayed image may be altered in response to received aspect ratio information, the reader is referred to European Patent EP 1,225,762.

One of the problems associated with switching a display to a new video signal, is that it takes time to determine the video picture formatting information, and hence to remove any black bars, or to perform any scaling to the active video portion. This time delay can be very irritating to users, particularly when they wish to quickly scan through video signals (for example TV channels) to see what video programmes are available.

Known displays often display the new video signal immediately, and then update the display after the video formatting information is determined. However, this is disturbing to the user, and can even result in the user concluding that the display is malfunctioning, leading to unnecessary customer service requests.

It is therefore an object of the invention to improve on the known art.

According to a first aspect of the invention, there is provided a method for displaying a video signal on a display, the method comprising:
receiving the video signal and displaying it within a destination window on the display; and
enlarging the destination window from an initially sized destination window to a finally sized destination window, and
   wherein the enlargement comprises:
in a first stage, enlarging the destination window at the same time as determining the format of the video pictures of the video signal; and
in a second stage, enlarging the destination window according to the determined format of the video pictures.

On receiving a video signal, the video signal is sent for display within a destination window area of the display. Then, the size of the destination window (and therefore the size of the video on the display) is enlarged. The enlargement initially takes place whilst the format of the video pictures is being determined, and then once the format of the video pictures has been determined, the enlargement continues, taking into account the formatting information.

Therefore, the user can immediately view a newly received video signal within the initially sized destination window, and there is a smooth transition between enlarging the destination window during the first stage without knowledge of the video formatting information, and then enlarging the destination window size during the second stage according to the video formatting information. The new video signal may be received as a result of the receiver receiving a command to display a video signal.

The enlargement of the destination window during the first stage is preferably timed to take at least as long as is required to determine the video formatting information. Then, the enlargement of the destination window in the second stage can immediately follow the enlargement of the destination window in the first stage, thereby minimising the disturbance to the user of the display.

Furthermore, the transition from the first stage to the second stage may be triggered as a result of the completion of the determination of the video format, such that the second stage begins as soon as the video format information becomes available for use.

Advantageously, the video formatting information may specify areas of active and inactive video content within the video pictures. Then, during the second stage, the active video content of the video picture may be enlarged to fill the whole of the destination window, thereby excluding the inactive video content of the video pictures from the destination window (and therefore from the display).

Additionally, the video formatting information may also specify the aspect ratio at which the active video content is to be displayed. Then, during the second stage, the destination window may be enlarged to match the aspect ratio at which the active video content is to be displayed.

According to a second aspect of the invention, there is provided software for causing a processor to carry out the method of the first aspect of the invention.

According to a third aspect of the invention, there is provided a video receiver comprising:
a video decoder adapted to receive and decode a video signal;
a video controller adapted to:
   send the decoded video signal to a destination window on a display; and
   enlarge the destination window from an initially sized destination window to a finally sized destination window; and
      wherein the enlargement comprises:
a first stage wherein the video controller enlarges the destination window at the same time as determining the format of the video pictures of the video signal;
a second stage wherein the video controller enlarges the destination window according to the determined format of the video pictures.

According to a fourth aspect of the invention, there is provided an apparatus comprising the video receiver of the third aspect of the invention, and a display device, the display device connected to the output of the video receiver for displaying the video signal.

Embodiments of the invention will now be described, by way of example only, and with reference to the accompanying drawings, in which:

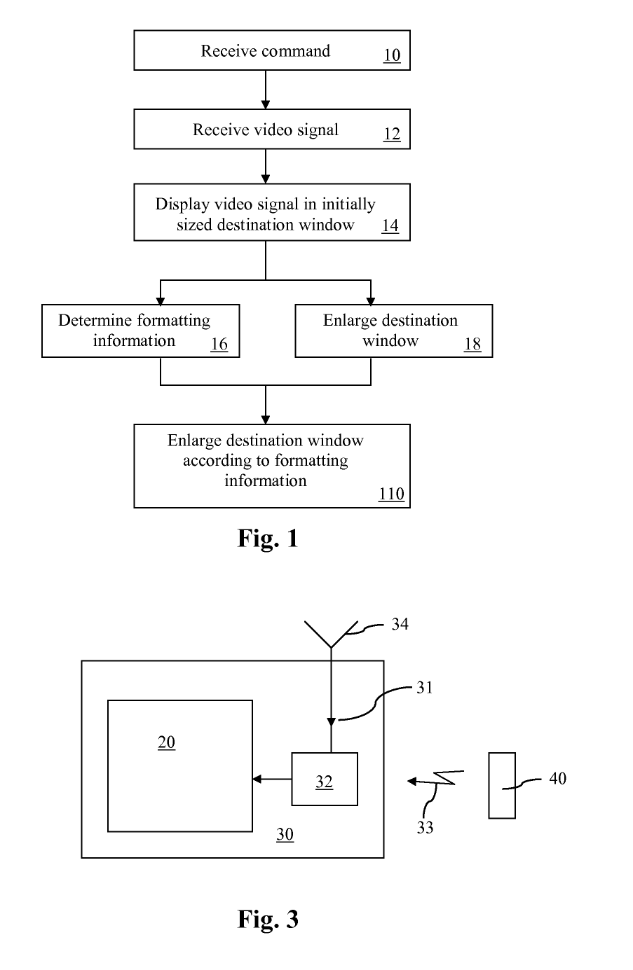

FIG. 1 shows a flow diagram of a method according to a first embodiment of the invention;

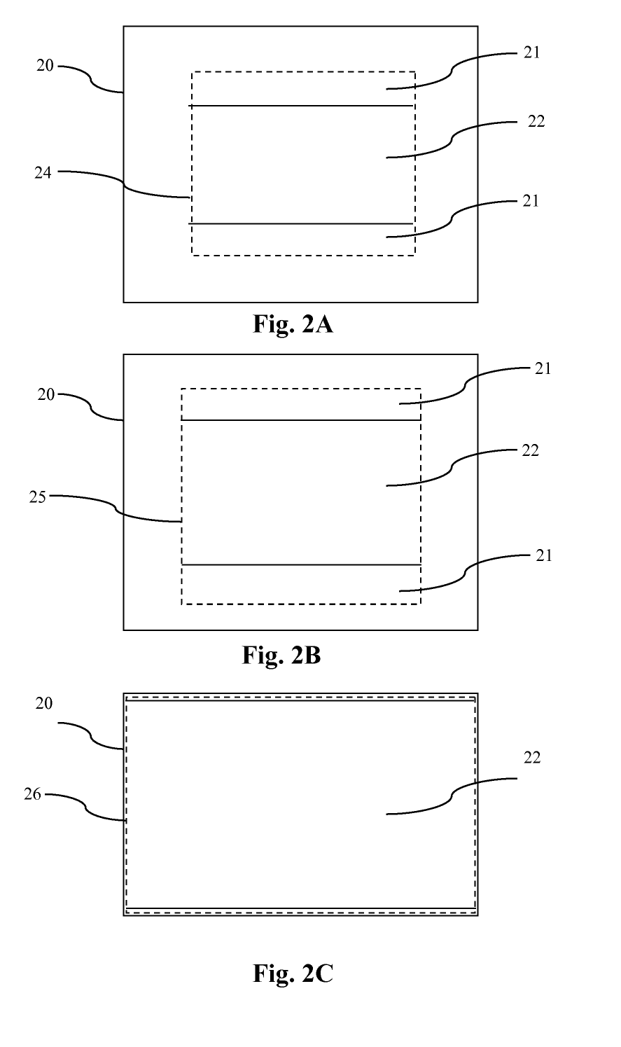

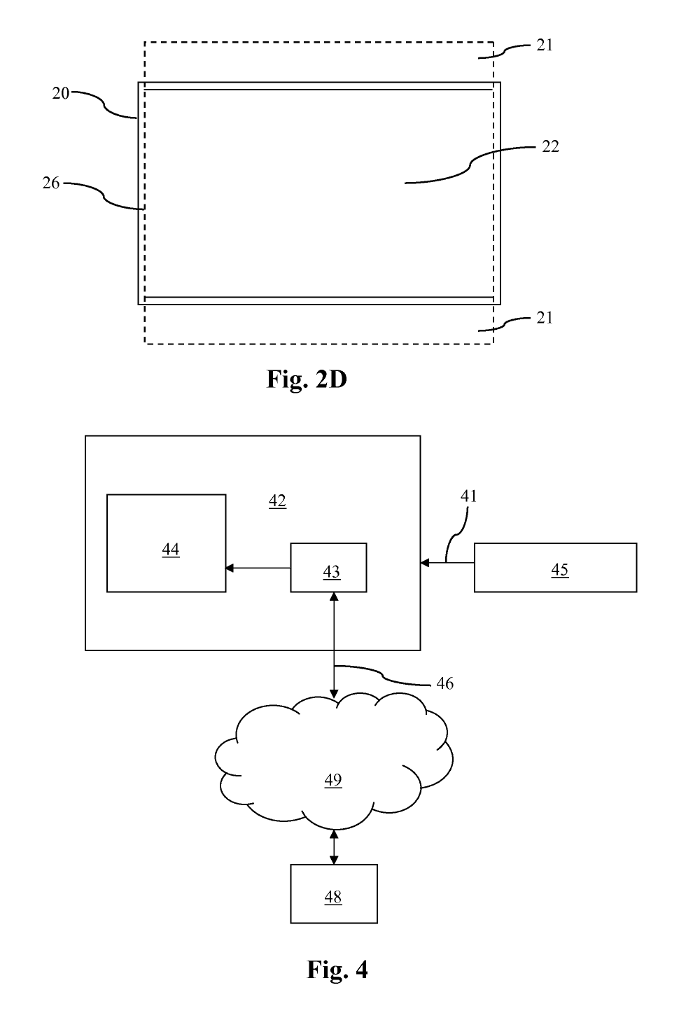

FIGS. 2A-2C show three diagrams of the display of a video signal according to the first embodiment;

FIG. 2D shows an alternate diagram to the diagram of FIG. 2C, according to an alternative embodiment.

FIG. 3 shows a television for displaying the video signal according to the first embodiment;

FIG. 4 shows a diagram of a computer system according to a second embodiment;

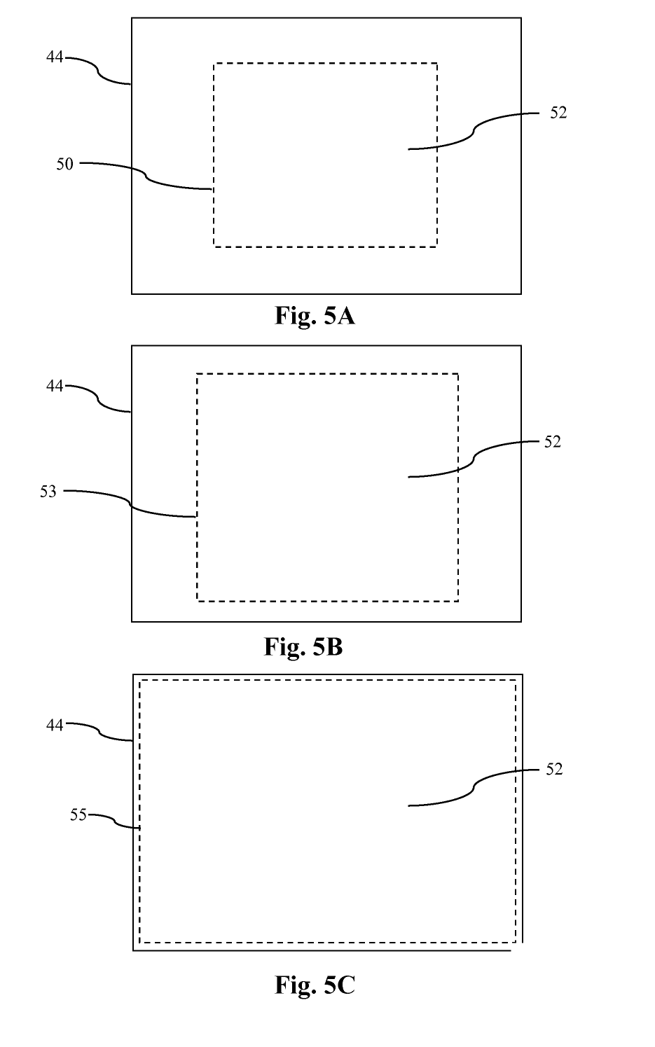

FIGS. 5A-5C show three diagrams of the display of a video signal according to the second embodiment.

The Figures are not drawn to scale, and same or similar reference signs denote same or similar features.

The first embodiment of the invention will now be described with reference to FIGS. 1, 2A-2C, and 3. FIG. 3 shows a television 30 comprising a television receiver (video receiver) 32, a 16:9 aspect ratio television display 20, and an aerial 34 for receiving a digital video signal 31 in a digital television broadcast. The television is controlled using a television remote control 35.

Firstly, at step 10 of FIG. 1, the television remote control 35 is used to send a command 33 to the television 30 to change to a new television channel (video signal). The television receiver 32 receives this command 33 and begins to receive the video signal 31.

Then, at step 14 of FIG. 1, the television receiver 32 decodes and sends the video pictures of the video signal 31 for display on the 16:9 aspect ratio television display 20. As shown on FIG. 2A, the video pictures are displayed within an initially sized destination window 24, and consist of active video content 22 at 16:9 aspect ratio, and inactive video content 21 in the form of black bars above and below the active video content 22. The initially sized destination window preferably fills at least 50% of the area of the television display 20.

Next, in a first stage, steps 16 and 18 of FIG. 1 are performed at the same time as one another. At step 16, the television receiver 32 determines the video formatting information by looking at the Digital Aspect Ratio and the Active Format Descriptor indications that are received with the Digital signal transmission. The Digital Aspect Ratio indicates that the aspect ratio of the video pictures is 4:3, and the Active Format Descriptor indicates that the video pictures are in a ‘letterbox’ format with the active video content having an aspect ratio of 16:9. The ‘letterbox’ format has inactive video content 21 (black bars) spaced above and below active video content 22, as will be apparent to those skilled in the art.

Many methods of determining the video formatting information are known in the art, such as reading codes sent within the video signal, as discussed in paragraph [0017] of European Patent Application EP 1 225 762 A2. Common methods of designating the aspect ratio of the video pictures include Wide Screen Signalling (WSS) for analogue television broadcasts, SCART Pin8 Aspect Ratio for SCART inputs and P50 Aspect Ratio for P50 protocol devices.

Further methods of determining video format information include averaging the video content over a length of time to determine any black bars that may be present in the video picture, and hence to determine the aspect ratio of the active video content.

At step 18, the television receiver 32 enlarges the destination window in which the video pictures are displayed on the television display 20. In the absence of any video formatting information, the destination window is enlarged without changing its aspect ratio. The enlargement is timed to take at least as long as is required to determine the video formatting information in step 16. At the end of step 18, the destination window has been enlarged to an intermediately sized destination window 25, and hence the video pictures now appear at a larger size on the television screen 20 shown in FIG. 2B.

Next, in a second stage at step 110, the television receiver enlarges the size of the destination window according to the determined video formatting information. As determined in step 16, the determined format of the video pictures is that the video pictures comprise 16:9 active video content and black bars above and below the active video content. Therefore, the television receiver 32 expands the destination window to a finally sized destination window 26 that has an aspect ratio of 16:9 to match the aspect ratio of the active video content 22, as shown on FIG. 2C.

In the first embodiment, as shown on FIG. 2C, the finally sized destination window 26 only extends as far as the boundaries of the display area. Therefore, during the second stage, the active video content is expanded to fill the whole of the destination window, thereby excluding the inactive video content from the destination window and hence from the display. In an alternative embodiment, as shown on FIG. 2D, the finally sized destination window 26 may extend beyond the area of the display 20, such that the active video content 22 falls within the area of the display and the inactive video content 21 falls outside of the area of the display.

The television receiver 32 is implemented by one or more processing units that are loaded with software, the software causing the television receiver to carry out the method as described above.

In the first embodiment, the initially sized destination window is smoothly (incrementally) enlarged to the intermediately sized destination window during a time period of around one second in the first stage, and the intermediately sized destination window is smoothly (incrementally) enlarged to the finally sized destination window during a further time period of around one second in the second stage. Therefore, the time between displaying a video picture of the new video signal within the initially sized destination window, and displaying the active portion of the video picture within the finally sized destination window, is around two seconds. Of course, many other time durations are possible, and the enlargement of the destination window in the first stage may take a different length of time to the enlargement of the destination window in the second stage.

Furthermore, instead of setting a fixed time for the length of the first stage, the video receiver may automatically proceed from the first stage to the second stage in response to completing the determination of the video formatting information.

Although the first embodiment describes the case where the video signal 31 is received following a command from a television remote control, in other embodiments the video signal may for example be received as a result of turning on the video receiver, or connecting a video input cable to the video receiver, or streaming a video signal from a server via the Internet.

The second embodiment of the invention will now be described with reference to FIGS. 4 and 5A-5C.

FIG. 4 shows a block diagram of a computer system 42 that is connected to a video server 48 via the Internet 49. The computer system 42 comprises an MPEG 2 video receiver 43, and a 16:9 aspect ratio monitor (display) 44.

In use, the computer system 42 receives a command 41 from the keyboard 45 to stream an MPEG 2 video signal 46 from the video server 48, and to display the video pictures of the video signal 46 on the computer monitor 44.

Once the MPEG 2 receiver begins to receive the MPEG 2 video stream (signal), it sends the video pictures of the video signal for display on the computer monitor 44 within an initially sized destination window 50, as shown on FIG. 5A. The video pictures have an aspect ratio of 4:3, and comprise 16:9 active video content 52 that has been horizontally scaled to fit within the 4:3 aspect ratio video pictures.

Then the destination window is incrementally enlarged during the first stage to an intermediately sized destination window 53, as shown in FIG. 5B. Simultaneously to this enlargement, the MPEG 2 receiver 43 looks at the DAR (Display Aspect Ratio) flag and Active Format Descriptor(AFD) of the MPEG 2 video stream, and determines that the format of the video pictures is such that they contain 16:9 active video content that has been horizontally scaled to fit within the 4:3 aspect ratio video pictures.

Then, the destination window is incrementally enlarged during the second stage to a finally sized destination window 55, as shown in FIG. 5C. The incremental enlargement in the second stage takes into account the determined video format information, so that the finally sized destination window has an aspect ratio of 16:9 to match the aspect ratio of the active video content.

The MPEG 2 video receiver 43 comprises a decoder for decoding the MPEG 2 video signal, and a video controller for sending the video signal to the display monitor 44. In this embodiment, the video decoder and the video controller are formed by a processor on a PCI (Peripheral Component Interconnect) expansion card of the computer system 42. Those skilled in the art will appreciate that this is just one example of how the video receiver 43 may be implemented, and that many different implementations may easily be conceived. The software for causing the video receiver 43 to act as described above may have been loaded into the computer system 42 from a software carrier such as a DVD-ROM, or may have been downloaded into the video receiver 43 from the Internet.

Within both the first and second embodiments, the enlargement of the destination window takes place smoothly (incrementally) over a length of time, helping to reduce the disturbance to the user of the display. The time used for the enlargement of the destination window during the first stage is utilised by the receiver to determine the format of the video pictures (video formatting information). The time used for the enlargement of the destination window during the second stage enables the destination window to gradually enlarge to the correct aspect ratio, and enables the active video content to gradually fill the whole of the destination window to the exclusion of any inactive video content that may be present, thereby minimising the disruption to the user of the display.

In summary, there is provided a method for displaying a video signal on a display, a video receiver, and software. When the video signal is received, the video receiver displays the video pictures of the video signal within a reduced-size window on the display. Then, the size of the reduced-size window is gradually increased, and the video receiver simultaneously detects the format of the video pictures. Once the format of the video pictures has been detected, the size of the window continues to be increased, but taking into account the detected format, thereby finally giving a full-size window that matches the format of the video pictures.

From reading the present disclosure, other variations and modifications will be apparent to the skilled person. Such variations and modifications may involve equivalent and other features which are already known in the art, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A method for displaying a video signal on a display, the method comprising:
receiving the video signal and displaying it within a destination window on the display; and
enlarging the destination window from an initially sized destination window to a finally sized destination window, and
wherein the enlargement comprises:
in a first stage, enlarging the destination window at the same time as determining the format of the video pictures of the video signal; and
in a second stage, enlarging the destination window according to the determined format of the video pictures.

2. A method according to claim 1, wherein the enlargement during the first stage is timed to take at least as long as the time required to determine the format of the video pictures.

3. A method according to claim 2, wherein the second stage begins in response to the format of the video pictures having been determined.

4. A method according to claim 1, wherein determining the format of the video pictures comprises determining an active portion of the video pictures.

5. A method according to claim 4, wherein determining an active portion of the video pictures comprises receiving image formatting information within the video signal.

6. A method according to claim 4, wherein determining an active portion of the video pictures comprises detecting whether the video pictures comprise black bars.

7. A method according to claim 4, further comprising determining a scaling factor of the active video portion.

8. A method according to claim 1, wherein the video pictures comprise active portions and inactive portions, wherein both active and inactive portions are sent for display within the initially sized destination window, and wherein only the active portion is sent for display within the finally sized destination window.

9. A method according to claim 8, wherein the active portion is expanded to fill at least substantially the whole of the destination window during the second stage.

10. A method according to claim 1, wherein during the first stage the enlargement (18) comprises maintaining the destination window at a fixed aspect ratio.

11. A method according to claim 1, wherein during the second stage the enlargement comprises changing an aspect ratio of the destination window according to the determined format of the video pictures.

12. A method according to claim 11, wherein the aspect ratio of the finally sized destination window is substantially the same as an aspect ratio of the active video content of the video pictures.

13. A method according to claim 1, wherein the video pictures comprise active portions and inactive portions, and wherein the finally sized destination window extends beyond the area of the display, the active video content being within the area of the display and the inactive video content being outside of the area of the display.

14. Software for causing a video receiver to carry out the method of claim 1.

15. A video receiver comprising:
a video decoder adapted to receive and to decode a video signal;
a video controller adapted to:
send a decoded video signal to a destination window on a display; and
enlarge the destination window from an initially sized destination window to a finally sized destination window; and
wherein the enlargement comprises:
a first stage wherein the video controller enlarges the destination window at a same time as determining a format of the video pictures of the video signal;
a second stage wherein the video controller enlarges the destination window according to the determined format of the video pictures.

16. Apparatus comprising the video receiver of claim 16 and a display device, the display device connected to an output of the video receiver for displaying the video signal.
